(19) United States
(12) Patent Application Publication
(10) Pub. No.: US 2019/0255465 A1
(43) Pub. Date: Aug. 22, 2019

(54) Irrigation Coupling with Integral Filter

(71) Applicant: Magnatronix Corporation, Clearwater, FL (US)

(72) Inventor: Tate RC Mayo, St. Petersburg, FL (US)

(21) Appl. No.: 15/898,831

(22) Filed: Feb. 19, 2018

(51) Int. Cl. B01D 29/11; A01G 25/02

(52) U.S. Cl. CPC B01D 29/114; A01G 25/023

(57) ABSTRACT

The disclosed device is an irrigation coupling with an integral filter. The irrigation coupling makes maintaining an irrigation system simpler and cheaper by using a small, replaceable component to strain sediment and debris from water in the system. The irrigation couplings prevent the sediment and debris from reaching sprinkler heads which in turn prevents the sprinkler heads, which are more expensive to replace, from clogging.

### FIELD

This invention relates to the field of irrigation systems and more particularly to an irrigation coupling having an integral filter.

### BACKGROUND

Irrigation is the process of providing water to plants at intervals to stimulate growth. Irrigation systems were developed as far back as five thousand years ago to help grow agricultural crops, maintain landscapes, and control dust.

Today, modern irrigation systems are used all over the world. It is agricultural irrigation that makes modern farming possible. Farmers can avoid the unpredictability of weather and provide crops with the ideal amount of water. There are many types of irrigation methods: surface irrigation, micro-irrigation, drip irrigation, sub-irrigation, and sprinkler irrigation.

An irrigation system takes water from a source, such as a tank, pond, or well, and distributes the water across an area, or to individual plants. A pump often serves as the driving force for the distribution, although gravity fed systems are also possible. Regardless, as the system takes in water from the water source, other materials (e.g. dirt, rock, sand, sediment, pests) become entrained.

One part of an irrigation system susceptible to clogging is the sprinkler heads. As the water moves through the secondary lines to sprinkler heads, sediments clog the lines and prevent proper functioning. One solution is to replace sprinkler heads as they cease to function. But replacing sprinkler heads is time consuming and costly.

What is needed is an inexpensive way of preventing sediment from reaching sprinkler heads, without increasing the complexity and cost of an irrigation system.

### SUMMARY

The solution to clogged sprinkler heads is an irrigation coupling with an integral filter.

Irrigation couplings connect the various water lines of an irrigation system. In a typical system, a main water line carries water from a water source, such as a well or storage tank to the field, crops, or vegetation where irrigation is needed. Secondary lines are joined to the main line at intervals. The secondary lines carry the water from the main line to a particular plant or area.

The secondary lines are joined to the main line using a coupling. The coupling has two barbed ends. The first barbed end is inserted into a hole in the main line. The second barbed end is inserted into a proximal end of a secondary line.

The irrigation coupling has an internal channel through which water passes from the main line into the secondary line. An integral filter is affixed within the internal channel. In some embodiments, the integral filter is a metal screen affixed to the coupling. In other embodiments, the coupling mold is formed with one end sealed and perforated to create the integral filter.

A general description of the flow of water in the system is as follows: water from the source moves through the main line, through the couplings, into the secondary lines, then to a sprinkler head for distribution to a field, crops, or vegetation.

The water flowing through the main line from the water source likely contains debris and sediment. As water in the main line reaches the couplings connecting secondary lines, the water then flows through the couplings and into the secondary lines. The debris or sediment is strained or blocked by the integral filter before it enters the secondary lines preventing the debris or sediment from reaching the sprinkler heads.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a schematic view of an exemplary irrigation system.

FIG. 2 illustrates a bottom perspective view of the irrigation coupling showing the integral filter.

FIG. 3 illustrates a front view, or lengthwise view, of the irrigation coupling with integral filter showing the internal channel.

FIG. 4 illustrates a side view, or widthwise view, of the irrigation coupling with integral filter.

FIG. 5 illustrates a view looking down at the first barbed end showing the integral filter.

FIG. 6 illustrates a view looking down at the second barbed end showing the internal channel.

FIG. 7 illustrates a close-up view of an irrigation coupling in use on an irrigation system.

FIG. 8 illustrates a cross-sectional, cut-away view of an exemplary irrigation system using multiple irrigation couplings on a single main line.

FIG. 9 illustrates the flow of water through an irrigation system using the irrigation coupling with integral filter.

FIG. 10 illustrates an alternative embodiment of the integral filter.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

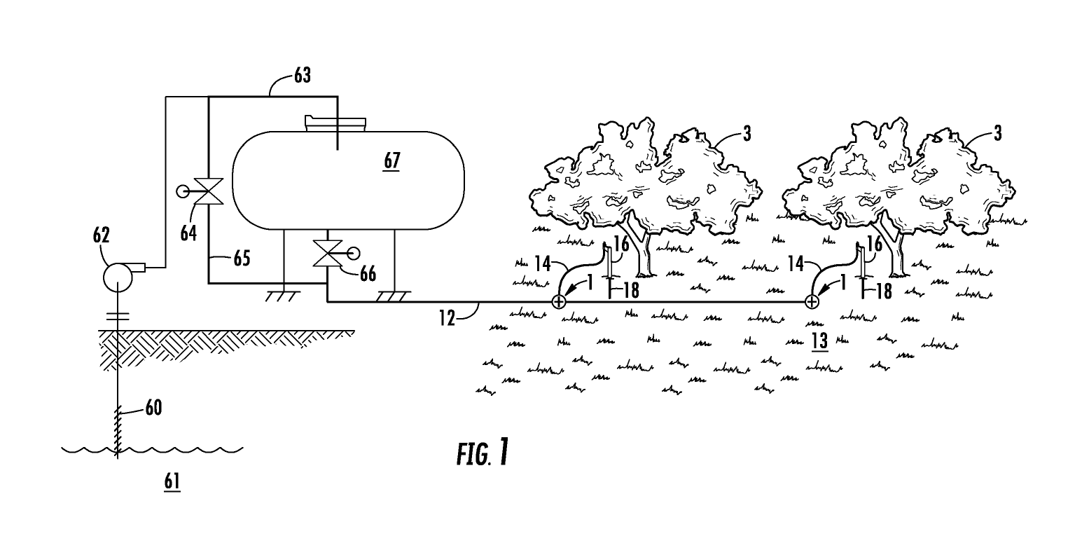

Referring to FIG. 1, an exemplary irrigation system is shown. The exemplary irrigation system utilizes well 60 or ground water 61 that is extracted from the earth via a pump 62. The water 61 is pumped directly to the target area 13 or into a tank 67 for storage.

If water 61 is pumped directly to the crops or vegetation 3, the bypass valve 64 is open and sends the water 61 to the main irrigation line 12 via the bypass line 65.

If water 61 is stored in the tank 66 for later use, the bypass valve 64 is closed, and the tank 66 is permitted to fill via the tank fill line 63. Then, when water for irrigation is required, the tank valve 66 opens to allow water from the tank 67 to move into the main irrigation line 12.

During irrigation, the water 61 flows through the main irrigation line 12 to the field or target area 13. In the field or target area 13, secondary irrigation lines 14 are used to divert a portion of the water 61 from the main irrigation line 12 to the plants or crops 3.

The secondary irrigation lines 14 connect to a sprinkler head 16 at or near the crops 3. The sprinkler head 16 is affixed to a sprinkler support 18.

As the water 61 moves through the main irrigation line 12, it likely contains entrained debris 20. In order to prevent clogging of the sprinkler heads 16, the irrigation couplings 1 are placed at the junctions where secondary irrigation lines 14 branch off the main irrigation line 12. Thus, the irrigation couplings 1 block or strain debris 20 from the water 61 before the water 61 reaches the sprinkler heads 16.

When the filter 2 in the irrigation coupling 1 becomes clogged, preventing water 61 from flowing through it, the irrigation coupling 1 can be replaced with less cost than replacing an entire sprinkler head 16.

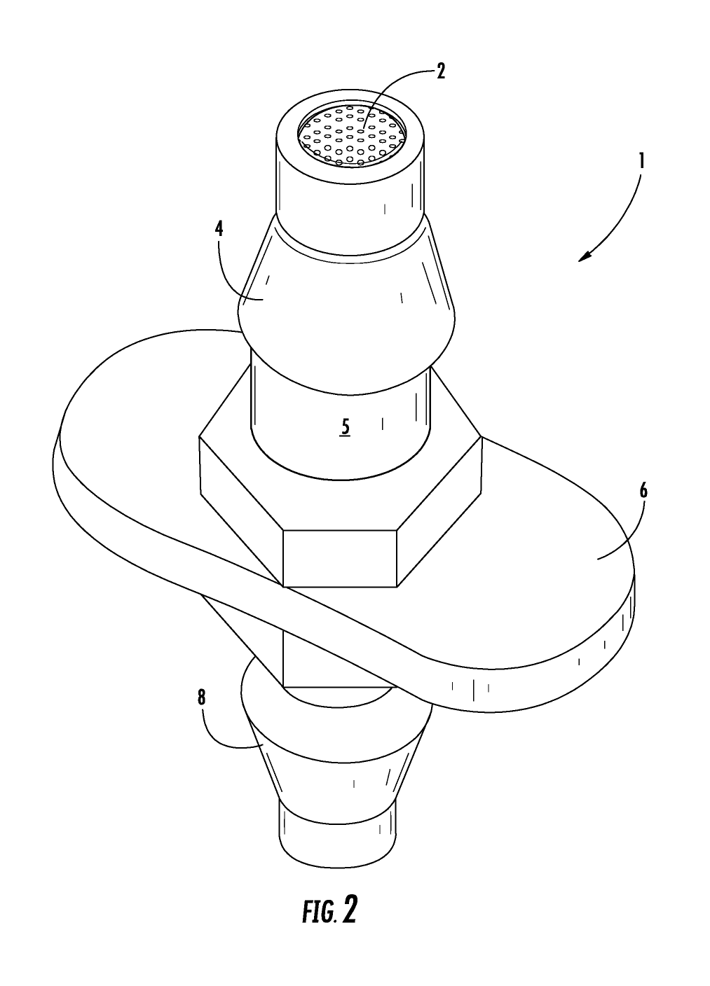

Referring to FIG. 2, a view of the irrigation coupling 1 is shown from a bottom perspective to show the integral filter 2. The irrigation coupling 1 is comprised of a main body 5, a first barbed end 4, a second barbed end 8, a collar 6, and an integral filter 2.

The irrigation coupling 1 is used with an irrigation system by inserting the first barbed end 4 into a hole on the main irrigation line 12. Then, the second barbed end 8 is inserted into a proximal end 15 of a secondary irrigation line 14. The barbed ends 4/8 create a secure connection holding the irrigation lines 12/14 in place.

The collar 6 acts to prevent over-insertion of the first barbed end 4 into the main irrigation line 12 and over-insertion of the second barbed end 8 into the secondary irrigation line 14.

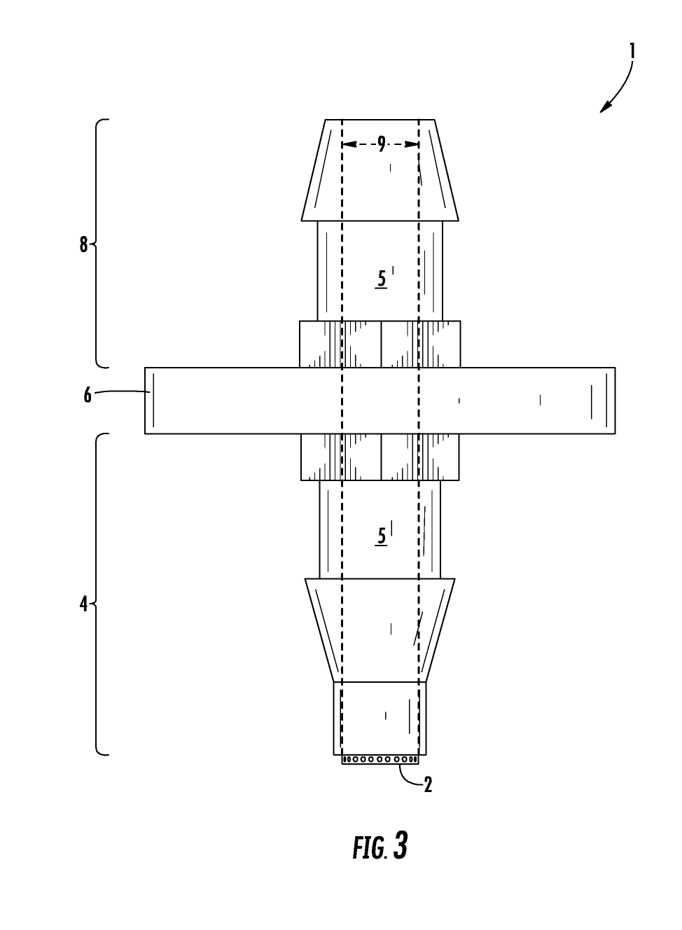

Referring to FIG. 3, a front view of the irrigation coupling 1 shows the length of the collar 6 and the internal channel 9. The internal channel 9 runs through the body 5 of the irrigation coupling 1, from the filter 2 out of the second barbed end 8. In some embodiments, the filter 2 is located on the first barbed end 4. In some embodiments, the filter 2 is located inside the internal channel 9.

In FIG. 3, the filter 2 is shown extending or raised from the first barbed end 4. The raised filter aids in repelling debris away from the internal channel 9. The debris will remain entrained in the water and flow to the end of the main irrigation line 12.

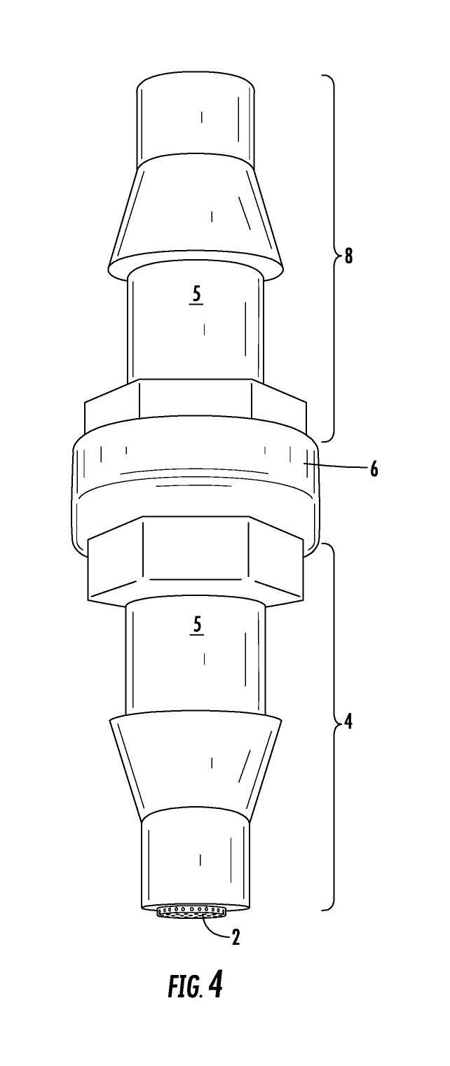

Referring to FIG. 4, a side view of the irrigation coupling 1 shows the width of the collar 6.

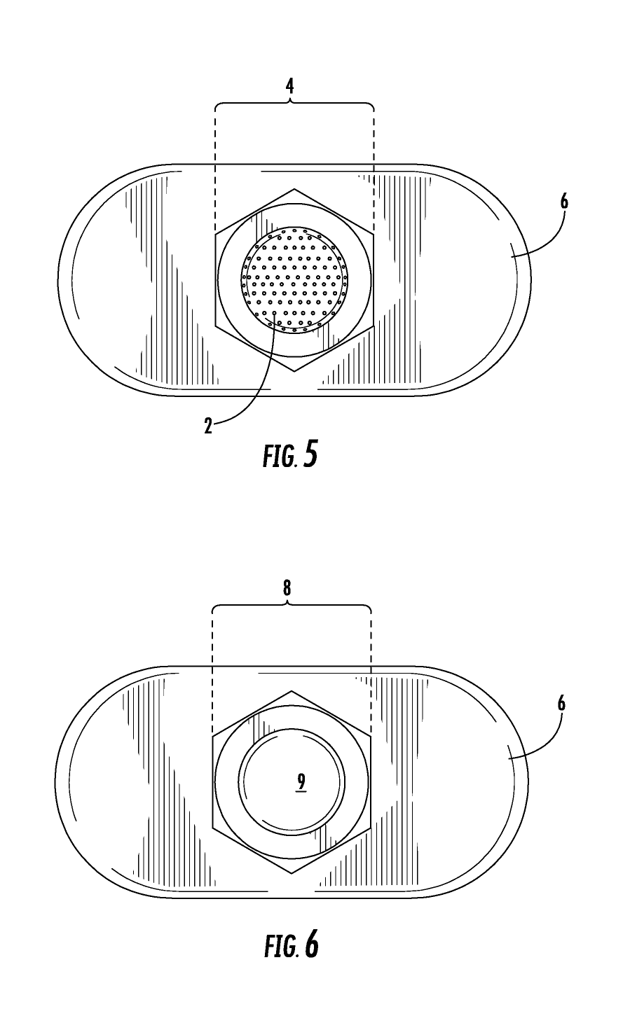

Referring to FIG. 5, a view looking down at the first barbed end 4 shows the integral filter 2.

Referring to FIG. 6, a bottom view looking down at the second barbed end 8 shows the internal channel 9.

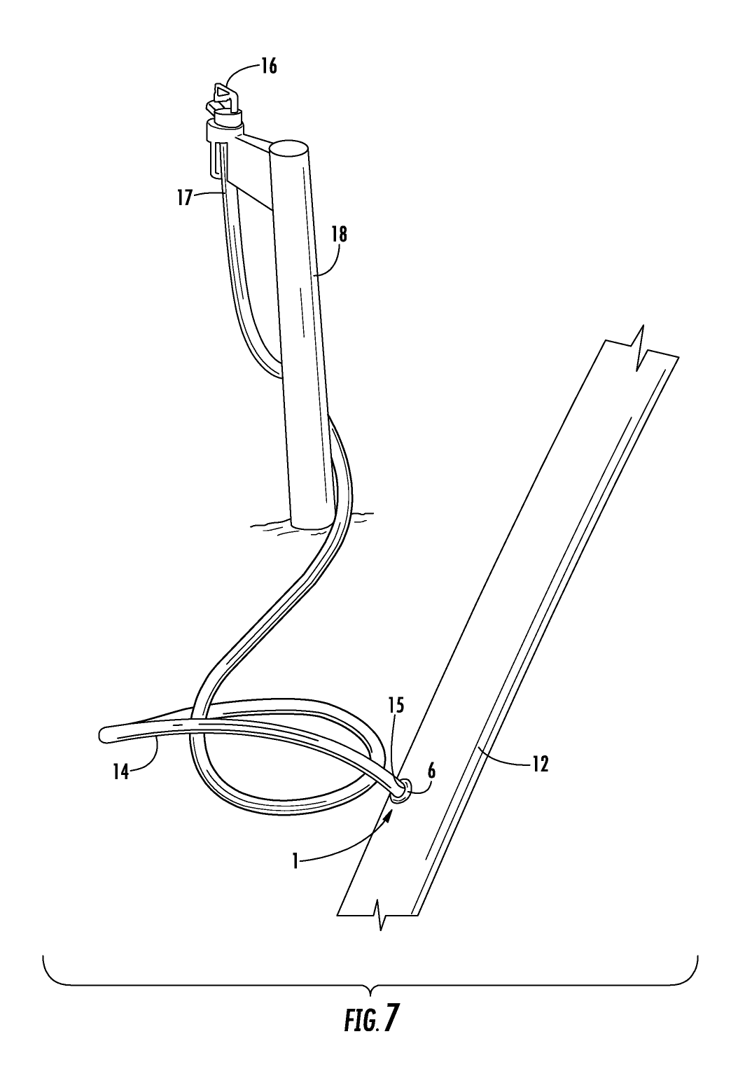

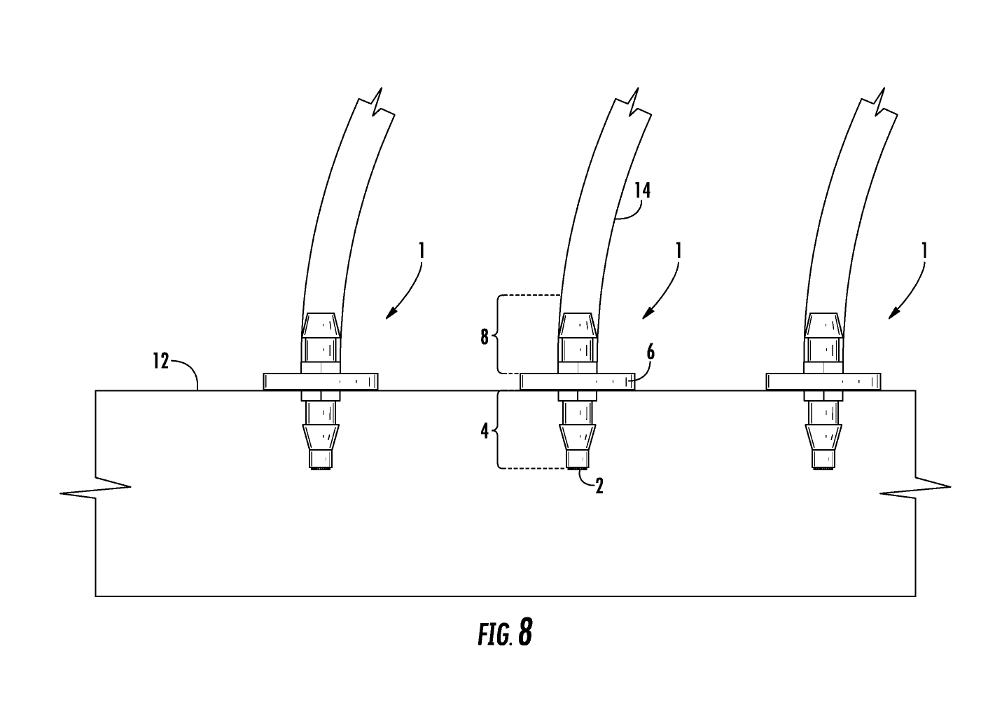

Referring to FIG. 7, a close up view of the irrigation coupling 1 is shown in use within an irrigation system.

In this figure, the first barbed end 4 is hidden, placed inside the main irrigation line 12. The collar 6 is shown preventing over-insertion. The second barbed end 8 is inserted into the proximal end 15 of the secondary irrigation line 14. And the terminal end 17 of the secondary irrigation line 14 connects to the sprinkler head 16. The sprinkler head support 18 holds the sprinkler head 16 in a desired location near a plant 3.

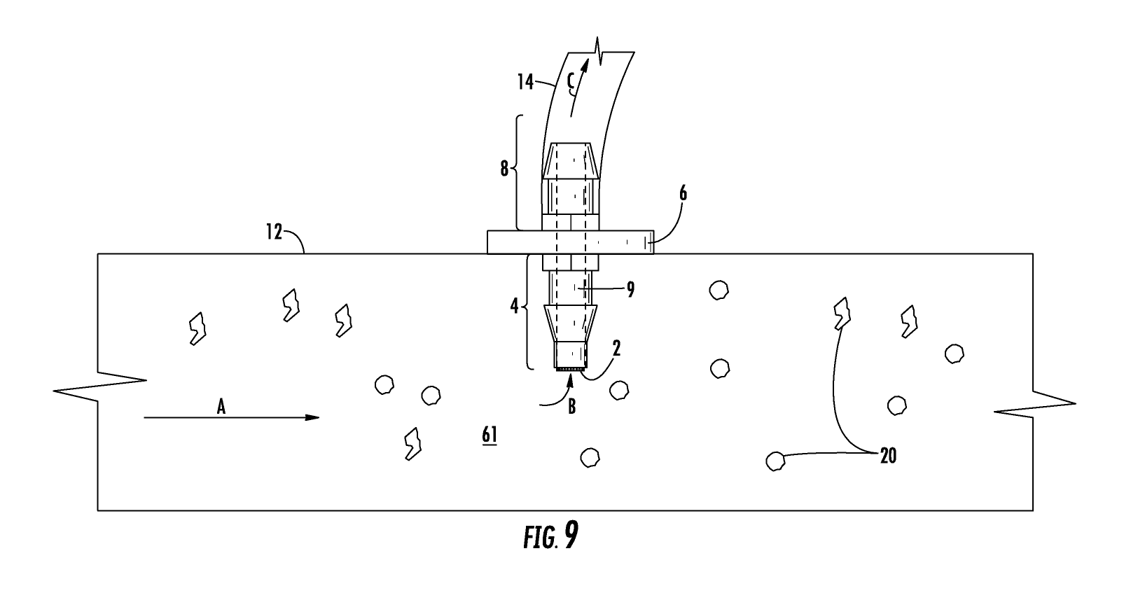

Referring to FIG. 8, a cut-away view shows multiple irrigation couplings 1 in use on a main irrigation line 12.

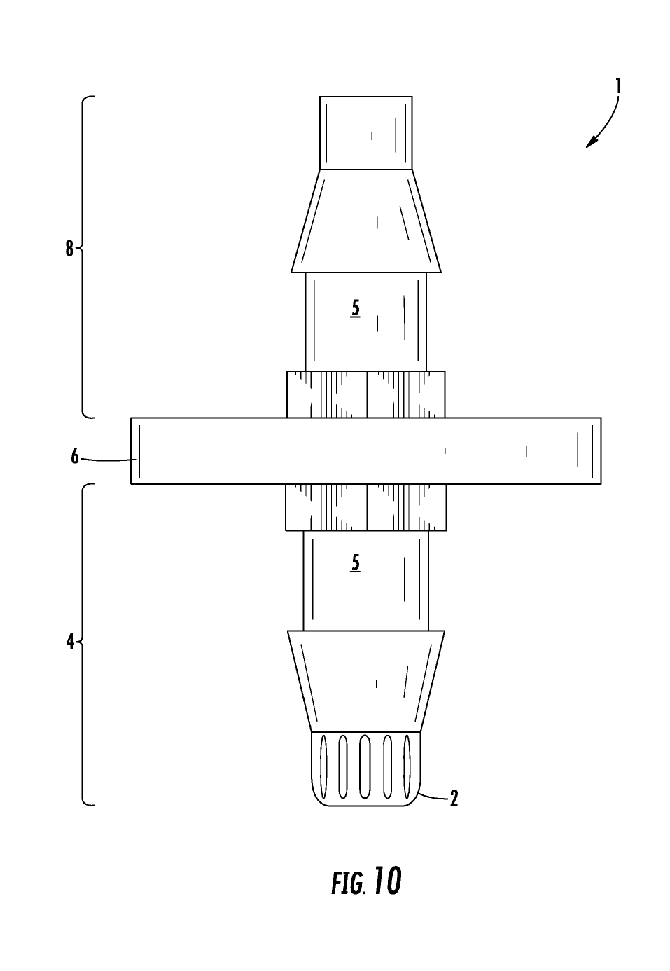

Referring to FIG. 9, the flow of water 61 through an irrigation system using the irrigation coupling 1 is shown.

A description of the flow of water 61 through the irrigation coupling 1 is helpful. First, water 61 flowing through the main line 12 has debris and sediment 20 entrained. This flow is shown as arrow A. The water 61 passes through the filter 2 and into the internal channel 9. The intake of water 61 is shown as arrow B. As the water 61 flows through the integral filter 2, the sediment and debris 20 is strained and water 61 flows, shown as arrow C, into the secondary line 14 to the sprinkler head 16 (not shown).

Referring to FIG. 10, an alternative embodiment of the integral filter is shown. In some embodiments, the integral filter 2 is a flat, circular attachment within the internal channel 9. But in other embodiments, the integral filter 2 extends outward from the first barbed end 4.

Depending on the type or size of anticipated debris or sediment, the filter 2 may have different pore sizes or slats to properly control the flow of water through the irrigation system.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. An irrigation coupling for connecting a secondary irrigation line to a main irrigation line, the coupling comprising:
a first barbed end;
a second barbed end;
a channel passing through a center of the irrigation fitting; and
an integral filter located within the channel;
wherein the integral filter blocks debris from entering the secondary irrigation line.

2. The irrigation coupling of claim 1, further comprising:
a transverse collar located between the first barbed end and the second barbed end;
wherein the transverse collar prevents over-insertion of the first barbed end into the main irrigation line and prevents over-insertion of the secondary irrigation line onto the second barbed end.

3. The irrigation coupling of claim 2, wherein the collar extends outward perpendicular to the channel.

4. An irrigation coupling for connecting a secondary irrigation line to a main irrigation line, the irrigation coupling comprising:
a body, the body having a first barbed end and a second barbed end;
a channel through the body;
an integral filter located on the first barbed end;
wherein the first barbed end secures the irrigation coupling in a hole in the main irrigation line and the second barbed end secures a connection to a terminal end of the secondary irrigation line; and
wherein the integral filter of the irrigation coupling strains sediment from the water as the water enters the channel.

5. The irrigation coupling of claim 4, further comprising;
a collar, the collar located on the body between the first barbed end and the second barbed end.

6. The irrigation coupling of claim 5, further comprising:
a midline of the body, the midline of the body located equidistant between the first barbed end and the second barbed end; and
wherein the collar extends outward perpendicularly from the midline of the body.

7. An irrigation coupling for use connecting a secondary irrigation line to a main irrigation line, the irrigation coupling comprising:
a body;
an internal channel running through the body;
an integral filter affixed within the internal channel;
wherein the integral filter removes entrained sediment from water as the water passes from the main irrigation line to the secondary irrigation line.

8. The irrigation coupling of claim 7, wherein the body further comprises:
a first barbed end, the first barbed end for insertion into a hole on the main irrigation line; and
a second barbed end, the second barbed end for insertion into a proximal end of the secondary irrigation line.

9. The irrigation coupling of claim 8, wherein the body further comprises:
a collar;
an equator;
the collar extending outwardly from the equator of the body; and
wherein the collar prevents over-insertion of the first barbed end and the second barbed end.
